(19) United States
(12) Patent Application Publication
(10) Pub. No.: US 2005/0262026 A1
(43) Pub. Date: Nov. 24, 2005

(54) Authorisation system

(76) Inventor: Daniel Robert Watkins, Bristol (GB)

Correspondence Address: Jay F. Moldovanyi, Esq.;Fay, Sharpe, Fagan, Minnich & McKee, LLP, Seventh Floor, 1100 Superior Avenue, Cleveland, OH, 44114-2518, US

(21) Appl. No.: 11/128,101

(22) Filed: May 12, 2005

(30) Foreign Application Priority Data
May 13, 2004 (GB) 0410724.9

(51) Int. Cl. G06F 17/60

(52) U.S. Cl. 705/67

(57) ABSTRACT

Systems and methods for securely authorising an on-line transaction, e.g. involving a micro-payment, between a customer browser and merchant server without the need for special software installed on the customer computer or a SSL connection to the merchant server. The authorisation method involves a double redirection instruction: the initial transaction request is redirected via the customer web browser to a service provider arranged to authenticate the customer, from where the authenticated instruction is further redirected via the customer web browser to a merchant site to complete the transaction. Information identifying the merchant, merchandise, etc. is included in the redirection instruction, and may be encrypted or encoded e.g. using a hash function to prevent tampering. To authorise an authenticated instruction, a cookie containing transaction identification data may be returned to the merchant web server along with the authenticated instruction. Alternatively, the service provider may set a time limit after which the authenticated instruction will no longer be valid.

### BACKGROUND OF THE INVENTION

1. Field of the Invention

The present invention relates to systems and methods for electronically authorising a transaction, i.e. allowing a transaction to take place, e.g. by authorising a user to gain remote access to private information held electronically. An example of such a system is a website that gives a user access to protected electronic information (PEI), e.g. journal articles, in return for payment. The invention is particularly aimed at micro-payment systems, where the payment amount is typically too small for normal credit card transactions to be cost-effective.

2. Description of the Prior Art

Micro-payment systems represent an alternative to subscription or the heavy use of advertising (e.g. pop-up advertising) to websites that offer access to discrete packages of information (e.g. news or scientific articles) in return for money.

Typically, a micro-payment system involves a trusted intermediary party (referred to herein as a service provider) between the purchaser (customer) and vendor (merchant). The purchaser and vendor each have an account with the service provider, so that when a transaction occurs between the purchaser and vendor, the service provider transfers funds from the purchaser account to the vendor account.

U.S. Pat. No. 5,329,589 (Fraser et al) discloses methods of and apparatus for mediating transactions carried out via a communication system, but it concerned primarily with provided the physical connection between parties to allow the necessary interaction.

Security is of fundamental importance in remote transactions, i.e. transactions where the purchaser and vendor are only remotely linked, e.g. by telephone or other electronic means. Without use of a trusted service provider, it is necessary for a purchaser to prove his identity to the vendor before a transaction is authorised to prove that payment has been made. This can be achieved by the purchaser sending identifying information (e.g. a password) directly to the vendor. However, the information needs to be sent in a secure fashion so that a third party cannot gain access to it and misuse it, e.g. by masquerading as the purchaser. The vendor needs to check that the purchaser's information is correct before authorising the transaction. This might be done by referring to a third party, e.g. a bank. This checking step also needs to be secure.

Known transaction systems use secure socket layer (SSL) communications, which protect communications between two remote locations from outside viewing. Using this type of communication increases the complexity of the web server having the SSL capability installed. SSL-based connections are commonly used to enable credit card transactions to be authorised. The extra complexity of the web servers can be justified in this case because of the relatively large payment amounts.

Using the known credit card SSL communications for micro-payment system is undesirable for two reasons. Firstly, the costs associated with processing credit card transactions means that it is commercially unviable to take small payment amounts using a credit card. Typically, it is only worthwhile to process credit card transactions for amounts greater than $1, whereas the cost of an item in a micro-payment system can be 10¢ or less. Secondly, each credit card transaction requires the purchaser to authenticate themselves; this process usually involves manually entering a large amount of information. This is not desirable for a micro-payment system, where a purchaser may wish to obtain many individual items in a short period. It would be very time-consuming to have to enter manually authentication information for each item.

Despite this, some existing micro-payment systems do require the purchaser to enter credentials identifying him each time a purchase is made, and to confirm his agreement to make the payment on each occasion. As mentioned above, while this is acceptable for occasional purchases, manually entering information, e.g. username and password, takes considerable time and presents a significant barrier preventing customers from making multiple purchases in quick succession, because the inconvenience of supplying identifying credentials and authorisation on each purchase is too great.

A number of micro-payment systems have been proposed which involve installing software on the purchaser's computer. However, many computer users are unwilling or unable to install software on their personal computers. This severely restricts the commercial viability of such solutions.

Micro-payment systems which require a direct exchange of information between a merchant's web server and a service provider for each payment transaction are also disadvantageous. Direct exchange of information introduces security risks unless the web server and service provider are able to verify each other's authenticity for each exchange. This can be done by using SSL communications, which has already been described as representing a commercial barrier to the merchant. Moreover, having a SSL certificate also increases both the bandwidth, time and processing overhead associated with each transaction.

Any payment service necessarily involves some communication between the customer and the merchant and/or the service provider. If these communications do not follow standard HTTP protocols they may be prevented by firewalls or other security-focused barriers on the network between the customer web browser and the merchant web server.

An object of the present invention is to provide an authorisation system which avoids or mitigates the problems listed above, and which may thereby provide a cheap, convenient and secure method for merchants to take small payments from customers in return for access to PEI published on the internet.

### SUMMARY OF THE INVENTION

At its most general, the present invention provides an authorisation system for an on-line transaction between a customer web browser and a merchant web server where there is no direct communication between the merchant web server and a service provider during a transaction; instead, a transaction request sent to the merchant web server from the customer web browser is redirected firstly from the merchant web server to the service provider via the customer web browser and secondly from the service provider to the merchant web server via the customer web browser. Data embedded in the transaction request each time it is redirected is used to give the system security and privacy. More security can be achieved by additionally using data sent in conventional internet cookies.

In a first aspect, the invention therefore may use a double redirection instruction together with returnable data packets (e.g. cookies) containing encrypted data to provide an authorisation system where sensitive information about the customer does not need to travel anywhere except between the customer and the service provider, thereby allowing the merchant web server to be of relatively simple construction. Moreover, all communication between the merchant server and the customer can be implemented using standard non-secure protocols without compromising security or customer privacy, i.e. without the need for an SSL certificate at the merchant web server.

The combination of data embedded in the redirected transaction requests and in the data packets may serve to indicate to the service provider that a redirected transaction request was issued by a particular merchant web server and to the merchant web server that a redirected transaction request was issued by that merchant web server. The request and embedded data may be encrypted to prevent a third party (e.g. the customer) in between the merchant web server and the service provider from tampering with the instruction without detection or from gaining access to secret data. The request and embedded data may be encrypted using an encryption method (e.g. a one-way encryption function and a password) known only to the merchant and service provider, such that the fact that the encryption result can be reproduced indicates in itself that the source of that information is trusted. The transaction request may also include information allowing the service provider to identify the merchant so that it can credit the correct account.

In the first aspect, the present invention preferably uses the fact that a conventional internet cookie is automatically returned to its originating web server whenever the same root domain is accessed. By incorporating data identifying a transaction into a cookie, the system of the present invention automatically creates a second source of information for the merchant web server to receive together with a redirected request. The data in the cookie is compared with data in the redirected transaction to provide the authorisation system with security.

Thus, according to the first aspect of the invention, there may be provided an authorisation system for an on-line transaction between a customer web browser and a merchant web server, the system including: a service provider that is remote from the merchant web server, the service provider being arranged to authenticate the identity of the customer; request identifying means for giving a first label to a transaction request from the customer web browser to the merchant web server, the request identifying means being arranged to cause a data package containing the first label to be sent from the merchant web server to the customer web browser; first redirection identifying means for providing the first label and a second label in a first redirection instruction sent from the merchant web server to the customer web browser, the second label including a first encrypted element unique to the merchant, the first redirection instruction causing the customer web browser to send a modified transaction request to the service provider, the modified transaction request including the first and second labels included in the first redirection instruction, the second label including the first encrypted element; second redirection identifying means for providing the first label included in the modified transaction request received by the service provider and a third label in a second redirection instruction sent from the service provider to the customer web browser, the third label including a second encrypted element unique to the service provider, the second redirection instruction causing the customer web browser to send a further modified transaction request to the merchant web server and return the data package to the merchant web server, the further modified transaction request including the first and third labels included in the second redirection instruction, the third label including a second encrypted element; first authentication means for authenticating the first encrypted element in the modified transaction request to indicate to the service provider that the source of the first redirection instruction is trusted and to detect tampering; and second authentication means for authenticating the second encrypted element in the further modified transaction request to indicate to the merchant web server that the source of the second redirection instruction is trusted and to prevent tampering; wherein: the service provider is arranged so that the second redirection instruction is sent when the first authentication means authenticates the first encrypted element; and the system includes a computer program arranged to authorise the transaction when: the second authentication means authenticates the second encrypted element; and the first label included in the further modified transaction request received by the merchant web server matches the first label in the data package that is returned to the merchant web server.

Preferably, the data package is a request cookie. The request cookie may be carried in the same HTTP header that specifies the first redirection instruction.

In this system, the customer need not share any identifying information with the merchant web server; all customer authentication occurs with the service provider. The merchant web server relies on data in the further modified transaction request to tell it that the customer is authentic. The second encrypted element tells the merchant web server that the further modified transaction request came from a trusted source, and if the first label in the further modified transaction request matches the first label in the request cookie, then the merchant web server can be sure that the further modified transaction request refers to the same transaction as the modified transaction request sent from that same merchant web server.

Thus, the customer may remain anonymous with respect to the merchant web server. This allows the merchant web server to be of relatively simple construction. Furthermore, the authorisation system of the present invention preferably does not require the customer to install software on his computer.

Preferably, the service provider is accessible via a website.

Preferably, the computer program is included in the merchant web server. The computer program may be accessed using a common gateway interface (CGI).

Preferably, the transaction request is an HTTP request. This means that the entire transaction may be carried out using the HTTP protocol. The present invention has effectively identified which parts of the transaction need to be secure from which parties and has proposed a system which may achieve this using standard internet protocols.

Preferably, the first redirection instruction includes a HTTP redirect header which instructs the customer web browser to send the modified transaction request to a first URL corresponding to the service provider's web site. The first URL may include the first and second labels.

Preferably, the second redirection instruction includes a second HTTP redirect header which instructs the customer web browser to redirect the further modified transaction request to a second URL corresponding to the merchant web server. The second URL may include the first and third labels.

Preferably, the service provider and the merchant web server share a secret such that the coding of the first and second encrypted elements demonstrates knowledge of the shared secret and preferably also enables the recipient to detect any change in the first or second URL respectively. The elements are encrypted so that an outside user (including the customer) who viewed them would be unable to work out the secret. Preferably, one or both of the first and second encrypted elements is the output of a one-way function which uses the shared secret. The one-way function may be a hash function. Alternative encrypted devices are possible, e.g. two-way functions such as a public/private key exchange or traditional single-key encryption.

Preferably, the transaction is the purchase of an item, and the first and/or second URL include an indication of that item and/or the cost of that item. This information is therefore passed from the merchant web server to the service provider via the customer web browser. Alternatively, an indication of the item may be stored in the request cookie, so that only the price of the item is sent to the service provider. When the request cookie returns to the merchant web server, the request cookie would tell the merchant what PEI to display. Yet another variation would be to send just the indication of the item, and rely on the service provider to look up the price in its database.

Preferably, the request cookie includes the time that it was issued, the IP address of the customer and a third encrypted element unique to the merchant web server, the third encrypted element being such that it can be authenticated by the merchant web server to detect tampering with the cookie. Thus, the request cookie can itself act as a security device by having a limited lifetime and by being able to show that the cookie has been sent from a different web browser from the web browser that made the initial request. The third encrypted element allows the merchant web server to make sure that the cookie was generated by itself.

Preferably, the computer program is arranged to check that the data contained in the returned cookie fulfils one or more of the following conditions: the third encrypted element corresponds to the correct merchant web server; the cookie has existed for no longer than a predetermined time period; the IP address in the cookie matches the IP address of the customer sending the confirmation request.

Preferably, the transaction involves a payment from the customer to the merchant, the service provider includes a first account for the customer and a second account for the merchant, and the service provider is arranged so that on receiving the first redirection instruction, it checks the first account to ascertain whether the customer has sufficient funds or credit to make the payment; and on sending the second redirection instruction, it debits the first account and credits the second account by an amount corresponding to the payment (plus or including commission as appropriate).

Preferably, the first account is customisable by the customer so that second redirection instructions are automatically issued by the service provider for individual payments below a certain amount. The customer may therefore pre-authorise the service provider to process purchases below a predetermined limit, which may be selected by the customer. The predetermined limit and other customer preferences may be saved in a secure database associated with the service provider.

Preferably, the service provider includes a web page with a facility to authenticate the customer. The facility may be of the known username/password type. Preferably, the service provider is arranged to issue an authentication cookie to the customer web browser after successful authentication of the customer, e.g. using the username/password facility, the authentication cookie including encrypted data to allow the customer to be identified by the service provider in subsequent requests without the need to re-authenticate. By using an authentication cookie, the customer may remain ‘logged in’ to the service provider throughout several visits to separate merchant web sites. Each merchant website may issue a redirection instruction to the customer web browser to redirect a transaction request to the service provider. This may automatically trigger the return of the authentication cookie. The service provider may contain means for checking for the presence of the authentication cookie. If present and valid, the service provider need not ask the customer to re-authenticate using e.g. the username/password. The transaction process is therefore more efficient. The authentication cookie may include an expiry time. The service provider website may be secured using an SSL certificate such that the authentication cookie and all communications between the customer web browser and the service provider, including requests that result from redirection instructions, are protected from eavesdropping.

Preferably, the balance of the first account is sent by the service provider to the customer web browser in a balance cookie. The service provider may include a balance web page for displaying the balance of the first account when accessed by the customer web browser, the displayed balance may be based on the value of the balance cookie. Customers may feel uncomfortable using a payment system that does not require authorisation of each payment unless they can see clear evidence that they are being charged correctly. The balance web page may give this aim by displaying the customer's account balance at all times while he is logged on.

Alternatively, the first aspect of the invention may be expressed as a method of authorising an on-line transaction between a customer web browser and a merchant web server after the customer web browser has sent a transaction request to the merchant web server, the method including the steps of: identifying the transaction request with a first label; sending a data package containing the first label to the customer web browser from the merchant web server; redirecting the customer web browser to a service provider that is remote from the merchant web server and is arranged to authenticate the identity of the customer, the redirecting step including: providing a second label for a first redirection instruction sent from the merchant web server to the customer web browser, the second label having a first encrypted element unique to the merchant; including the first label in the first redirection instruction; and sending a modified transaction request from the customer web browser to the service provider, the modified transaction request including the first and second labels included in the first redirection instruction, the second label including the first encrypted element unique to the merchant; confirming that the customer can be party to the transaction, the confirming step including: authenticating the first encrypted element; providing a third label for a second redirection instruction sent from the service provider to the customer web browser, the third label having a second encrypted element unique to the service provider; including the first label included in the modified transaction request in the second redirection instruction; sending a further modified transaction request from the customer web browser to the merchant web server, the further modified transaction request including the first and third labels included in the second redirection instruction, the third label including the second encrypted element; and returning the data package from the customer web browser to the merchant web server; and authorising the transaction, the authorising step including: authenticating the second encrypted element; and matching the first label included in the further modified transaction request received by the merchant web server with the first label sent in the data package that is returned to the merchant web server.

The present invention may benefit from one or more of the following advantages:
1. After “logging on” to the service provider, the authentication cookie sent from the service provider to the customer web browser means that the customer does not need to identify himself for each payment. This is true even when payments are made to a plurality of different merchant sites because each time there is a redirection to the service provider, which triggers the return of the authentication cookie to the service provider.
2. The customer does not need to authorise each payment individually because the service provider has a securely stored memory of a pre-authorised value and therefore allows a transaction requiring payment below this value automatically to proceed.
3. No direct communication between the merchant web server and the service provider is needed.
4. Furthermore, the invention exclusively utilizes communication techniques which conform to the HTTP standard, and are supported by most commonly used web browsers without being prevented by commonly used firewalls.

As a result of the ability of the invention to be wholly implemented using conventional internet protocol, this invention is described below using standard HTTP terms which will be understood by a reader familiar with this protocol. The invention may be worked using other conventional or proprietary protocols provided that a computer program on the customer's computer responds to redirection requests and embedded data in a similar fashion to a web browser's handling of these aspects of the HTTP protocol.

In a second aspect of the invention, alternative means are used to provide security, i.e. prevent copying of the authorised transaction. Essentially this works by setting a time limit on the validity of an authorisation made by the service provider. The authorisation (e.g. for a specified item at a specified location) must be used within a certain period or else the item will not be released as the authorisation will not be recognised as valid. Thus, in the second aspect of the invention, there may be provided an authorisation system for an on-line transaction between a customer web browser and a merchant web server, the system including: a service provider that is remote from the merchant web server, the service provider being arranged to authenticate the identity of the customer; a request identifier for giving a first label to a transaction request from the customer web browser to the merchant web server; a first redirection identifier for providing the first label and a second label in a first redirection instruction sent from the merchant web server to the customer web browser, the second label including a first encrypted element unique to the merchant, the first redirection instruction causing the customer web browser to send a modified transaction request to the service provider, the modified transaction request including the first and second labels included in the first redirection instruction, the second label including the first encrypted element; a second redirection identifier for providing the first label included in the modified transaction request received by the service provider and a third label in a second redirection instruction sent from the service provider to the customer web browser, the third label including a second encrypted element unique to the service provider, the second redirection instruction causing the customer web browser to send a further modified transaction request to the merchant web server, the further modified transaction request including the first and third labels included in the second redirection instruction, the third label including a second encrypted element; an expiry setter for including a fourth label indicative of a time limit in the second redirection instruction, the fourth label being included with the first and third labels in the further modified transaction request; a first authentication portion for authenticating the first encrypted element in the modified transaction request to indicate to the service provider that the source of the first redirection instruction is trusted; and a second authentication portion for authenticating the second encrypted element in the further modified transaction request to indicate to the merchant web server that the source of the second redirection instruction is trusted; wherein: the service provider is arranged so that the second redirection instruction is sent when the first authentication portion authenticates the first encrypted element; and the system includes a computer program arranged to authorise the transaction when: the second authentication portion authenticates the second encrypted element; and the time limit indicated by the fourth label has not expired.

The second aspect of the invention is therefore characterised by the presence of a time limit instead of a seed cookie. The time limit causes the transaction request to become ineffective after a predetermined period. The time limit may typically be set somewhere between 10 s and 1 minute. The lower limit is preferably long enough to allow time for the redirect to occur, and for minor variations in the clock time between the merchant server and the authorisation server. The upper limit is preferably short enough to prevent or discourage copying of the authorisation response for replay on another computer e.g. in order to obtain further access. If protection against copying between computers is especially important, these time limits may be reduced.

Preferably, the second authorisation portion includes a clock, and the fourth label includes a value for comparison with the clock. The service provider may periodically check the value of the clock to help accurately set the time limit indicated by the fourth label.

The merchant web server may include a merchant order web server for receiving the transaction request from the customer web browser, and a merchant delivery web server for receiving the further modified transaction request; and wherein the first redirection identifier is provided in the merchant order web server and the second authentication portion is provided in the merchant delivery web server. Thus, the order and delivery need not necessarily come from the same website. Indeed, the merchant order web server and the merchant delivery web server may have different web domain names. They may even belong to different parties, e.g. merchant A having website www.site1.com may sell material accessible on merchant B's website www.site2.com.

The optional and desirable elements of the structure of the first aspect of the invention may also be included in the system according to the second aspect of the invention.

For example, the transaction may be the purchase of an item, and the first URL can include one or both of an indication of the item and the cost of that item. The item may be electronic information, and the first URL may include an address, e.g. a web address, representing the location of the item to be purchased.

Alternatively, the second aspect of the invention may be expressed as a method of authorising an on-line transaction between a customer web browser and a merchant web server after the customer web browser has sent a transaction request to the merchant web server, the method including the steps of: identifying the transaction request with a first label; redirecting the customer web browser to a service provider that is remote from the merchant web server and is arranged to authenticate the identity of the customer, the redirecting step including: providing a second label for a first redirection instruction sent from the merchant web server to the customer web browser, the second label having a first encrypted element unique to the merchant; including the first label in the first redirection instruction; and sending a modified transaction request from the customer web browser to the service provider, the modified transaction request including the first and second labels included in the first redirection instruction, the second label including the first encrypted element unique to the merchant; confirming that the customer can be party to the transaction, the confirming step including: authenticating the first encrypted element; providing a third label for a second redirection instruction sent from the service provider to the customer web browser, the third label having a second encrypted element unique to the service provider; calculating an expiration time limit and providing a fourth label in the second redirection instruction that is indicative of the expiration time limit; including the first label included in the modified transaction request in the second redirection instruction; and sending a further modified transaction request from the customer web browser to the merchant web server, the further modified transaction request including the first, third and fourth labels included in the second redirection instruction, the third label including the second encrypted element; and authorising the transaction, the authorising step including: authenticating the second encrypted element; and checking that the time limit indicated by the fourth label has not expired.

In a further expression of the second aspect of the invention, there may be provided a method of authorising an on-line transaction between a customer web browser and a merchant web server after the customer web browser has sent a transaction request to the merchant web server, the method including the steps of: identifying the transaction request with a first label; redirecting the customer web browser to a service provider that is remote from the merchant web server, the redirecting step including: providing a second label for a first redirection instruction sent from the merchant web server to the customer web browser, the second label having a first encrypted element unique to the merchant; including in the first redirection instruction a third label to correspond to the first label; and sending a modified transaction request from the customer web browser to the service provider, the modified transaction request including: a fourth label to correspond to the third label; and a fifth label to correspond to the second label, the fifth label including a first security element to correspond to the first encrypted element; checking the authenticity of the customer, whereby: if the customer is not authentic, the transaction is terminated, and if the customer is authentic, the method includes the step of: attempting to validate the first security element, whereby: if the first security element cannot be validated, the transaction is terminated, and if the first security element is validated, the method includes the steps of: redirecting the customer web browser to the merchant web server, the redirecting step including: providing a sixth label for a second redirection instruction sent from the service provider to the customer web browser, the sixth label having a second encrypted element unique to the service provider; including in the second redirection instruction a seventh label to correspond to the fourth label; calculating an expiration time limit and providing an eighth label in the second redirection instruction that is indicative of the expiration time limit; and sending a further modified transaction request from the customer web browser to the merchant web server, the further modified transaction request including: an ninth label to correspond to the seventh label; and a tenth label to correspond to the sixth label, the tenth label including a second security element to correspond to the second encrypted element; and attempting to authorise the transaction, the attempting step including: attempting to validate the second security element, whereby: if the second security element cannot be validated, the transaction is terminated, and if the second security element is validated, the attempting step includes: checking that the time limit indicated by the eighth label has not expired, whereby: if the time limit has expired, the transaction is terminated, and if the time limit has not expired, the transaction is authorised.

Preferably, the transaction is a request from the customer to view material stored on the merchant web server, and wherein the method includes the step of sending the material from the merchant web server to the customer web browser if the transaction is authorised.

The second aspect of the invention may also be expressed as a web server for authorising an on-line transaction request received from a customer web browser, the web server including: a request identifier for giving a first label to a transaction request from the customer web browser; a first redirection identifier for providing the first label and a second label in a first redirection instruction sent to the customer web browser, the second label including a first encrypted element unique to the web server, the first redirection instruction causing the customer web browser to send a modified transaction request to a service provider that is remote from the merchant web server in order for the service provider to authenticate the identity of the customer, whereby a second redirection instruction is issued to the customer web browser to cause the customer web browser to send a further modified transaction request to the web server, the second redirection instruction and the further modified transaction request including a third label which includes a second encrypted element unique to the service provider and a fourth label indicative of an expiry time; an authentication portion for authenticating the second encrypted element contained with the further modified transaction request received from the customer web browser; and a computer program arranged to authorise the transaction when: the authentication portion authenticates the second encrypted element; and the time indicated by the fourth label has not expired.

### BRIEF DESCRIPTION OF THE DRAWINGS

Examples which embody the invention are described below with reference to the accompanying drawings, in which:

FIG. 1 is a schematic block diagram illustrating the relationship between the customer, the merchant, and the service provider;

FIG. 2 is a block diagram illustrating a customer logging on to a service provider's website to authenticate;

FIG. 3 is a block diagram illustrating the balance web page function;

FIG. 4 is a block diagram illustrating an initial transaction request from a customer web browser to a merchant web server;

FIG. 5 is a block diagram illustrating a first redirection instruction;

FIG. 6 is a block diagram illustrating the response to the first redirection instruction;

FIG. 7 is a block diagram illustrating a second redirection instruction;

FIG. 8 is a block diagram illustrating the response to the second redirection instruction;

FIG. 9 is a block diagram illustrating the supply of purchased information from the merchant web server;

FIG. 10 is a block diagram illustrating a request for an embedded image;

FIG. 11 is a block diagram illustrating the response to the request for an embedded image; and

FIG. 12 is a block diagram illustrating an authorisation system that is a second embodiment of the invention.

### DETAILED DESCRIPTION OF THE PREFERRED EMBODIMENTS

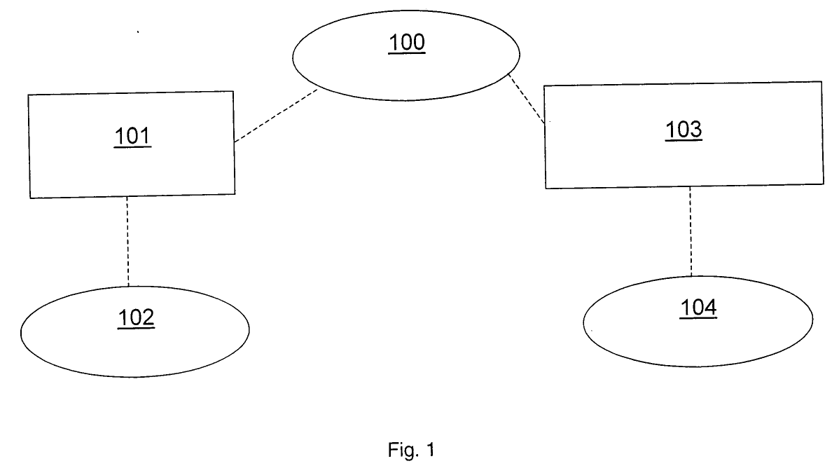

FIG. 1 shows the relationship in which the present invention operates. A service provider 100 is related to both a merchant 102 and a customer 104 through a merchant account 101 and customer account 103 respectively. The service provider 100 is arranged to debit or credit the accounts when a transaction is authorised. The service provider 100 contains a secure database which stores the balance of the merchant account 101 and the customer account 103.

In order that the service provider 100 can recognise communications from the merchant 102, the service provider 100 shares a secret with the merchant 102. The shared secret enables the service provider 100 and merchant 102 to authenticate received encoded information as having originated from the other party. This shared secret could take the form of a password that is encoded using a one way hash function. The customer 104 and service provider 100 also share a secret to enable the service provider 100 to authenticate the customer 104. This shared secret may be a username and password.

To reduce the amount of information that is transmitted on each transaction, the service provider 100 also has stored in its secure database a list of the items of private electronic information (PEI) available from the merchant 102 together with the price of each item.

The service provider 100 can determine whether the customer 104 has funds available to pay for a transaction. The customer 104 may add to his account by a deposit of funds at the service provider or his funds may be based on a credit arrangement with the service provider 100.

The service provider 100 also stores preference settings for the customer 104 on the secure database. The preference settings include a payment threshold value; transactions involving a payment below the payment threshold value are not required to be individually authorised. The preference settings may be set differently for different merchants or some other criteria, or may be set uniformly for all websites.

The service provider 100 can maintain an account balance showing the aggregate total value of payments made to the merchant 102.

The steps involved in making a transaction using the system of the present invention are now described. The transaction occurs between a customer web browser 106, from which the customer 104 has access to a merchant web server 110 through a web site, and to a service provider web site 108 provided by the service provider 100. The merchant web server 110 offers items of private electronic information.

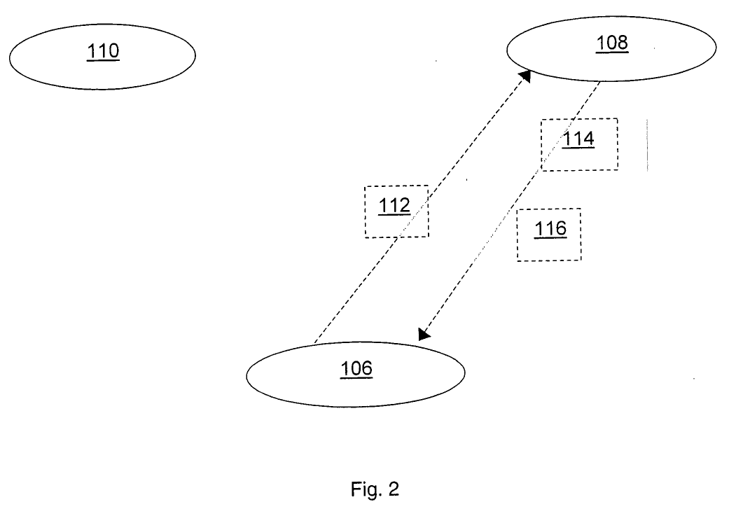

FIG. 2 shows the customer 104 submitting his or her shared secret 112 to the service provider website 108 to be authenticated by the service provider 100. The website 108 uses SSL security to protect any information exchanged with customers and standard techniques to identify the customer 104 across multiple HTTP Requests by issuing an encrypted authentication cookie 114 as part of the response header to a successful authentication by the customer 104. While the authentication cookie 114 exists, and until an expiry time encoded within the cookie 114, the customer 104 can be identified by the service provider website 108 each time the customer web browser 106 makes contact with the service provider website 108. The customer 104 is therefore logged on to service provider 100.

The service provider website 108 also issues a balance cookie 116 containing the customer's current balance. For example, the cookie may contain the value balance=$10.00.

It is important to note that any cookie is only exchanged between the customer web browser 106 and websites under the root domain of the website that issued the cookie. So, the information contained in the authentication cookie 114 and balance cookie 116 is only available to websites under control of the service provider 108. It is not sent to the merchant web server 110.

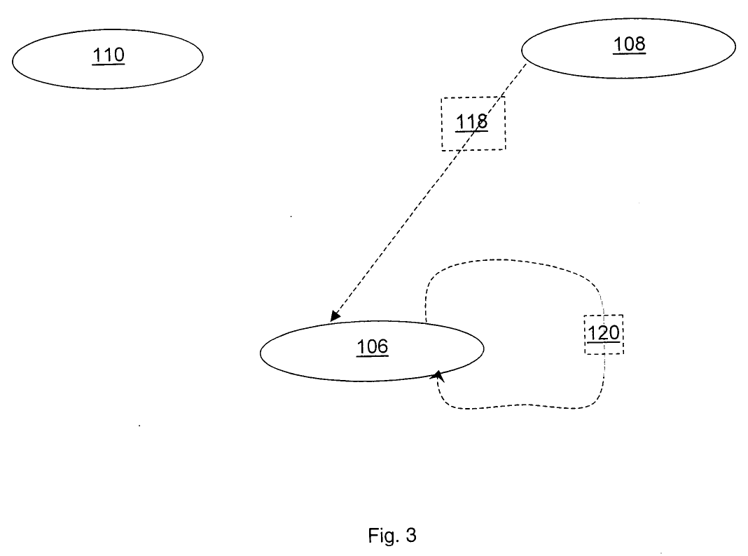

FIG. 3 shows that the service provider website 108 provides a balance web page 118 that enables the customer 104 to view his account balance through the customer web browser 106 at any time. The balance web page 118 is published under the same root domain as the service provider website 108 that issues the balance cookie 116. The balance web page 118 includes code 120 to run periodically at the customer web browser 106 to display the customer's account balance based on the content of the balance cookie 116. By running the code 120 in the customer web browser 106 every few seconds, the balance web page 118 appears to be updated almost instantly with the customer's new account balance whenever the balance cookie 116 is re-issued by the service provider website 108.

The balance web page 118 is displayed in any convenient form that provides the balance information to the customer 104 as he or she makes payments. These might include:

a) Displaying the balance web page 118 within an <IFRAME> tag on a merchant website, thereby making the balance appear within each merchant's website.

b) Displaying the balance web page 118 as a separate web page designed to be constantly viewable by the customer regardless of what other pages he is viewing.

The merchant will use the standard facilities of the merchant web server 110 to ensure that the PEI is not made freely available to surfers on the website that gives access to the web server. This may be achieved by configuring the merchant web server 110 to refuse read-access to that PEI, or to require submission of a password before allowing read access. For example, the PEI may be held at a location with the following address http://www.merchantsite.com/protected/pei_page1.html, where the /protected directory has no read access for HTTP requests.

The merchant web server 110 has a software program provided by the service provider 100 installed on it to extend the facilities of the merchant web server 110. The computer program uses the “Common Gateway Interface (CGI)”. The merchant web server 110 has a freely available web page that offers links to the protected information via the software program. For example, the merchant web server 110 will publish HTML pages on its website containing links to the software program on his website using the standard “<A>” syntax, e.g. <A href=/cgi-bin/program.exe?url=protected/pei_page1.html&price=0.01> click here for page 1 price one cent</A>. The link includes parameters to identify the content to be purchased by its URL (e.g. url=protected/pei_page1.html) and the price to be charged (e.g. price=0.01), together with descriptive information inviting the user to click the link in order to get access to the PEI at the price indicated.

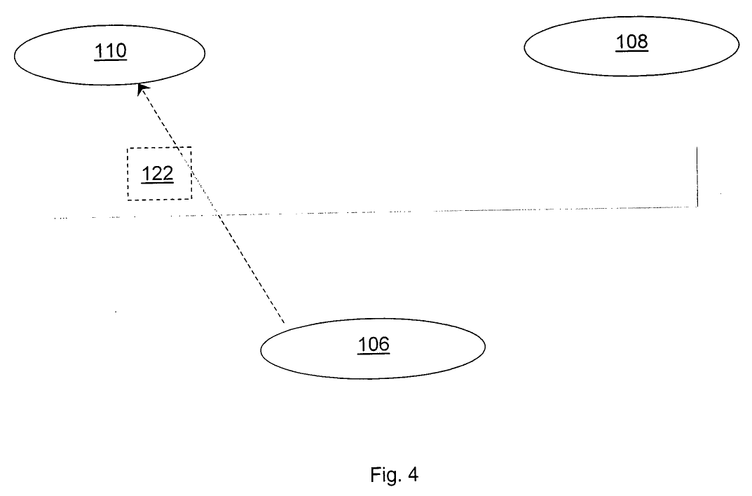

FIG. 4 shows the software program being activated by the customer web browser 106 sending a transaction request 122 to the merchant web server 110. The transaction request 122 is an HTTP request to the computer program (indicated by its activation path, e.g. http://www.merchantsite.com/cgi-bin/program.exe), sent when the customer 104 clicks on the link, e.g. the transaction request 122 issued when the above-mentioned link is selected is:

GET http://www.merchantsite.com/cgi-bin/program.exe?url=protected/pei_page1.html&price=0.01

The shared secret between the service provider 100 and the merchant 102 is used by the software program as described below.

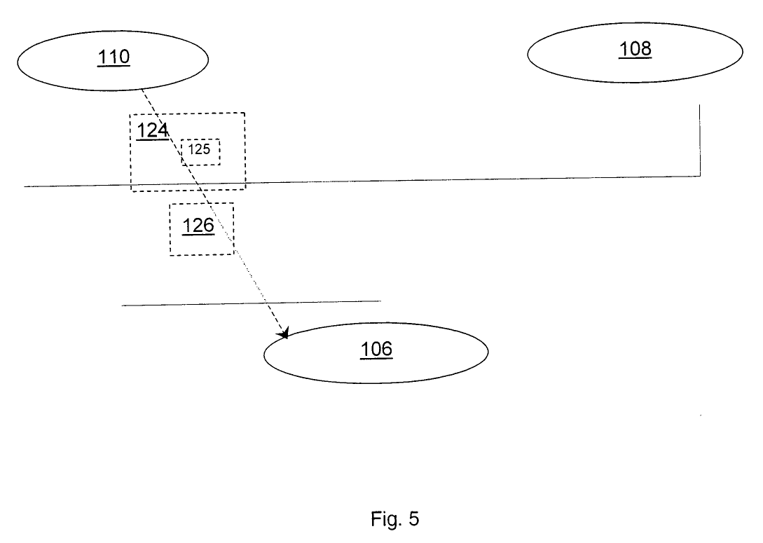

FIG. 5 shows how the computer program in the merchant web server 110 responds to the transaction request 122. A first redirection instruction 124 in the form of a HTTP redirect header is sent from the merchant web server 110 to the customer web browser 106 to tell the customer web browser 106 to redirect its request to the web site operated by the service provider. The first redirection instruction 124 includes a first redirection URL 125, e.g.

http://www.serviceprovider.com/payment.aspx?url=protected/pei_page1.html&price=0.01&seed=1234&ref=www.trafficsite.com&hash=xxxxx

The first redirection URL 125 includes the following parameters:
1. An indication of the content being purchased (e.g. the location (URL) of the PEI—url=protected/pei_page1.html);
2. The price to be charged—price=0.01;
3. A seed value identifying the transaction—seed=1234;
4. Details of a website that referred the customer 104 to the merchant web server 110, e.g. ref=www.trafficsite.com; and
5. An encoded value which would demonstrate to the service provider 100 that the sender of the redirection instruction 124 has knowledge of the shared secret, without revealing that secret to anyone examining the first redirection URL 125, and also ensuring that the URL 125 has not been tampered with. This value may be an MD5 hash value of the entire URL 125 including the parameters (but excluding the hash parameter itself), combined with the shared secret. Any modification to the URL or any parameter would result in the hash being rendered invalid so that the recipient can detect the modification, e.g. hash=xxxxx.

At the same time as sending the first redirection instruction 124, the merchant web server also issues a seed cookie 126, which contains the following information:
1. The same seed value identifying the transaction as contained in the first redirection instruction 124—seed=1234;
2. The time the seed cookie 126 was issued—time=14:34;
3. The IP address of the customer—Customer-IP=123.123.123.123;
4. An encoded value that can be used to determine if the content of the seed cookie has been tampered with by a person who does not have knowledge of a secret held by the merchant 102, for example using the same technique as was described for URL 125—Hash=yyyyy.

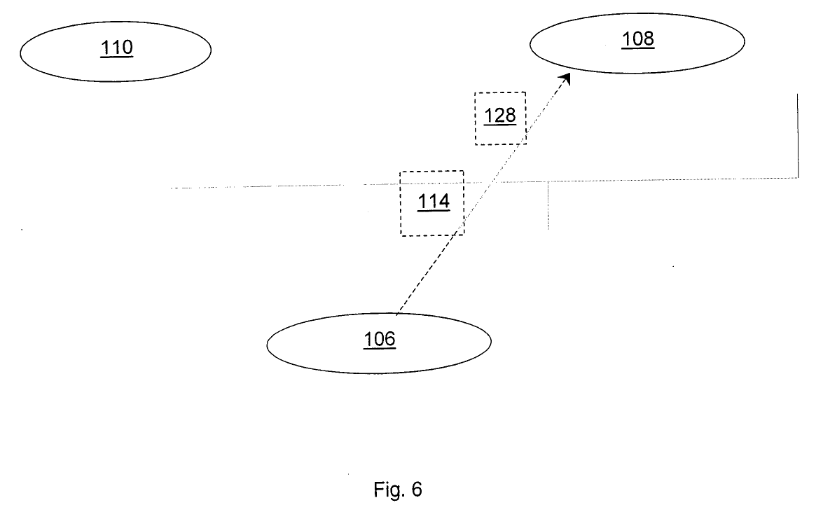

FIG. 6 shows the response of the customer web browser 106 to receiving the first redirection instruction 124. When it receives the HTTP redirect header contained in the first redirection instruction 124, the customer web browser 106 follows the HTTP redirection by issuing a modified transaction request 128 to the service provider website 108. The modified transaction request 128 contains the first redirection URL 125, e.g. it has the form GET http://www.serviceprovider.com/payment.aspx?url=protected/pei_page1.html&price=0.01&seed=1234&ref=www.trafficsite.com&hash=xxxxx. Thus, information included by the merchant in the first redirection URL 125 is automatically sent to the service provider website 108.

In accordance with HTTP protocol, the modified transaction request 128 will be accompanied by any cookies previously issued to the customer web browser 106 by the service provider website 108. Thus, the authentication cookie 114 is returned to the service provider website 108. The service provider website 108 will examine received information for the authentication cookie 114, which if present indicates to the service provider 100 that the customer 104 is currently logged on. If the authentication cookie 114 is not present or has expired, the service provider website 108 asks the customer 104 to re-authenticate. If the authentication cookie 114 is present, the service provider website 108 will check its database to ascertain whether the following three preliminary conditions are satisfied:
1. That the customer 104 has sufficient funds or credit to meet the requested payment; and
2. That the payment amount is below the amount that must be individually authorised according to the customer's preferences.
3. That the hash value within the modified transaction request 128 demonstrates knowledge of the shared secret and that entire coding of modified transaction request 128 has not been tampered with.

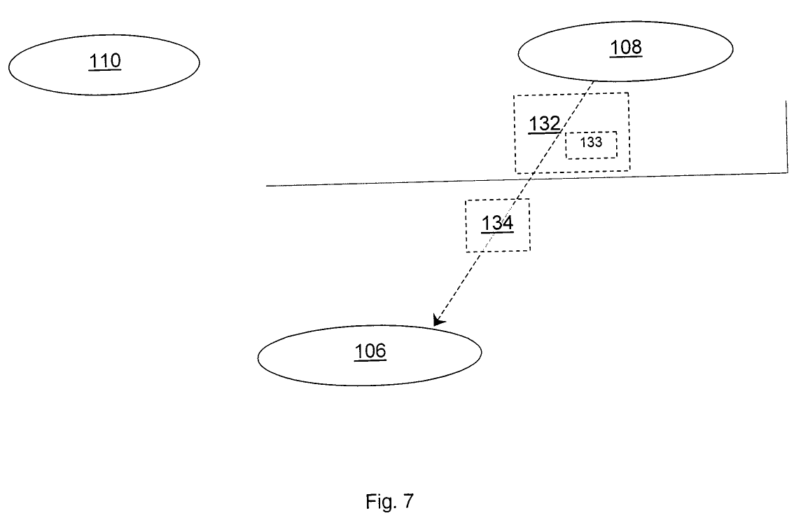

FIG. 7 shows the response of the service provider website 108 if both the preliminary conditions are satisfied. In addition, the service provider 100 checks its database to match up the information contained in the modified transaction request 128. The “HTTP_REFERRER” header value that automatically accompanies the modified transaction request 128 (according to the HTTP protocol specification) tells the service provider 100 the URL of the website that issued the first redirection instruction 124. By checking this URL against its database of websites under control of each merchant, the Service Provider 100 can determine the merchant. The service provider can also check that the price included in the redirection URL 125 matches the price in the database for the PEI item identified in the redirection URL 125. When the service provider is satisfied that no tampering has taken place, it debits the customer's account with the amount of the payment and credits the merchant's account with the amount of the payment.

The response of the service provider website is to issue a second redirection instruction 132 in the form of a HTTP redirect header to the customer web browser 106 telling it to redirect its request back to the computer program on the merchant web server 110. The second redirection instruction 132 includes a second redirection URL 133, e.g. http://www.merchantsite.com/cgi-bin/program.exe/protected/pei_page1.html&seed=1234&hash=zzzzz.

The second redirection URL 133 includes the following parameters:
1. An indication of the content to be provided to the customer, encoded as additional path information appended to the computer program URL—/protected/pei_page1.html;
2. The seed value received by the service provider in the modified transaction request 128—seed=1234;
3. An encoded value which would demonstrate to the merchant 102 that the sender of the second redirection instruction 132 has knowledge of the shared secret, without revealing that secret to anyone examining the second redirection URL 133, and also ensuring that the URL 133 has not been tampered with. This value may be an MD5 hash value of the entire URL 133 including the parameters (but excluding the hash parameter itself), combined with the shared secret. Any modification to the URL or any parameter would result in the hash being rendered invalid so that the recipient can detect the modification, e.g. hash=zzzzz.

The service provider web site also issues an updated balance cookie 134 at the same time as sending the second redirection instruction 132. The updated balance cookie 134 contains the new customer account balance, e.g. balance=$9.99.

If details of a referring website were included in the first redirection URL 125 (coded in this example using ref=www.trafficsite.com) and hence in the modified transaction request 128, and the owner of the referring website has previously established a relationship with the service provider 100, the service provider 100 may credit an account owned by the referring website with a payment as a reward for sending customers to the merchant web server 110.

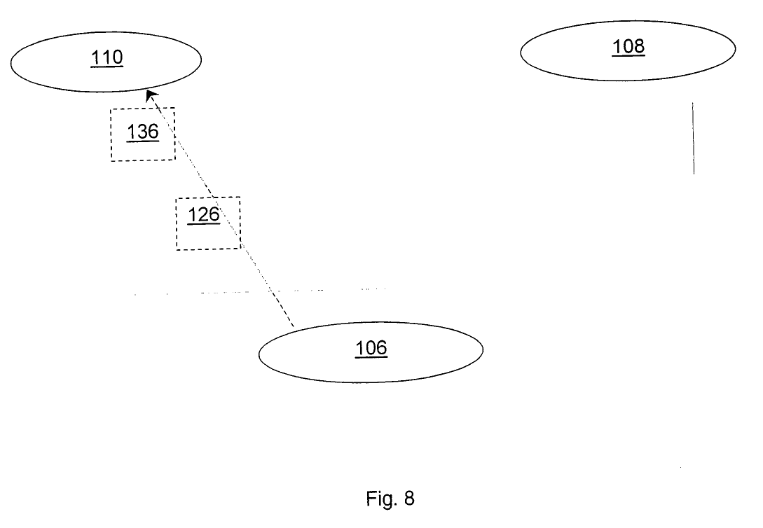

FIG. 8 shows the response of the customer web browser 106 to the receipt of the second redirection instruction 132. When it receives the HTTP redirect header contained in the second redirection instruction 132, the customer web browser 106 follows the HTTP redirection by issuing a further modified transaction request 136 to the computer program on the merchant web server 110. The further modified transaction request 136 contains the second redirection URL 133, e.g. it has the form GET http://www.merchantsite.com/cgi-bin/program.exe/protected/pei_page1.html&seed=1234&hash=zzzzz. Thus, information included by the service provider 100 in the second redirection URL 133 is automatically sent to the merchant web server 110.

In accordance with HTTP protocol, the further modified transaction request 136 is accompanied by any cookies previously issued to the customer web browser 106 by the merchant web server 110. Thus, the seed cookie 126 is returned to the merchant web server 110.

The computer program checks that the following conditions are satisfied:
1. The hash value in the second redirection URL 133 in the further modified transaction request 136 correctly demonstrates knowledge of the shared secret and that the entire coding of URL 133 has not been tampered with.
2. A seed cookie 126 accompanies the further modified transaction request 136 and contains a seed value that matches the seed value contained in the second redirection URL 133.
3. The seed cookie 126 has not been tampered with, i.e. the encoded value (hash=yyyyy) in the seed cookie 126 confirms that it originated in the merchant web server 110 and no change has since been made to the content of that cookie.
4. The seed cookie 126 was issued no earlier than a certain number of minutes ago to prevent old cookies from being reused.
5. That the IP address in the seed cookie 126 matches the IP address of the customer sending the further modified transaction request 136, to prevent the cookie being used by a second customer.

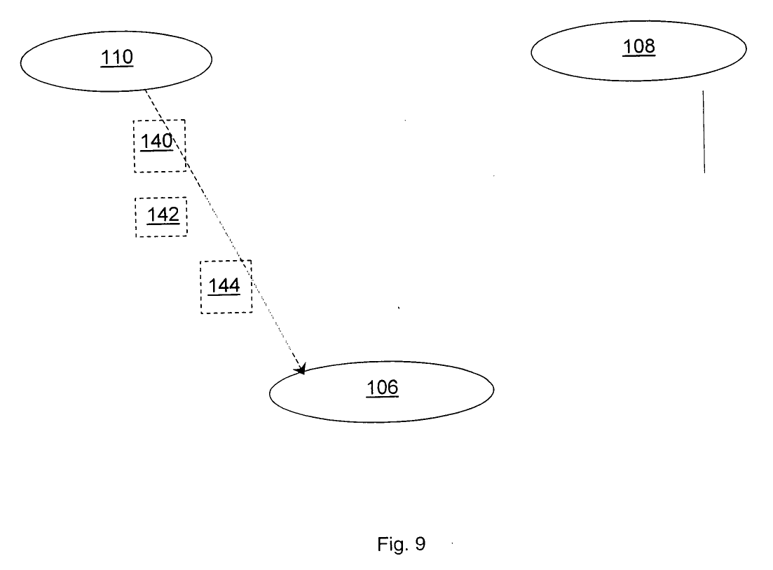

FIG. 9 shows the response of the computer program if the above conditions are met. The merchant web server sends out an instruction in the form of a delete cookie 142 which instructs the customer web browser 106 to delete the seed cookie 126, thereby preventing the transaction from being repeated later. The delete cookie may include the value Seed=“ ”.

The PEI 140 that the customer has purchased in the transaction will be returned to the customer web browser 106, e.g. through a HTTP response of the form

HTTP RESPONSE 200 OK
<HEAD> <TITLE>Welcome to PEI_Page1.htm</TITLE></HEAD>
<BODY>
...<IMG src=image.gif>...
</BODY>

If the PEI 140 is to be delivered to the customer web browser 106 in response to more than one transaction request (e.g. a supplementary request might be made to view pictures referenced by an HTML page, or to allow access to more than one page of PEI for a certain period in return for the single payment made), an access cookie 144 is also issued.

The access cookie 144 (if required) contains the following information:
1. The time after which no further access to the PEI is to be allowed, e.g. Time=15.34.
2. The set of PEI to which access should be permitted without causing redirection to the service provider website 108, e.g. Directory=/protected.
3. The IP address of the customer web browser 106, e.g. IP=123.123.123.123.
4. An encoded value that can be used to determine if the content of the access cookie has been tampered with by a person who does not have knowledge of a secret held by the merchant 102—hash=DDDDD.

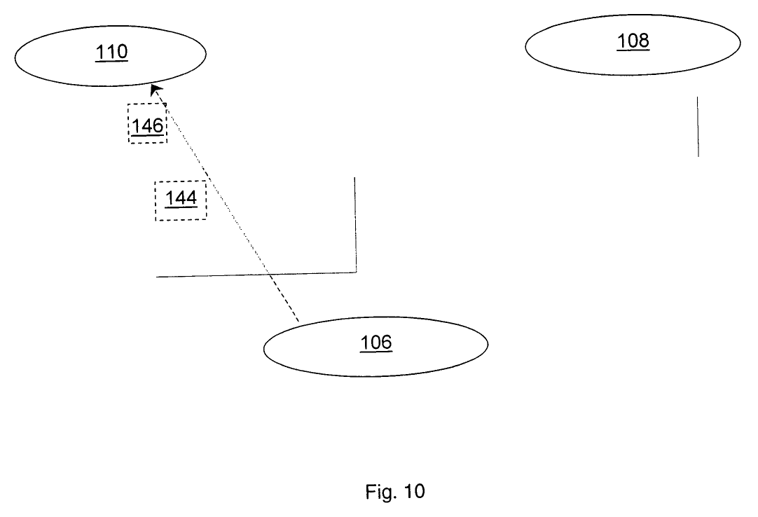

The customer web browser 106 processes the received page(s) in the normal way. FIG. 10 shows the customer web browser sending a supplementary request 146 for e.g. a linked picture or hyper-linked document. Again, HTTP protocol requires any cookies sent by the merchant web server 110 to be returned to it when another request is made. Thus, the access cookie 144 is returned with the supplementary request 146. The request 146 includes a path containing the computer program URL, e.g. GET http://www.merchantsite.com/cgi-bin/program.exe/protected/image.gif, whereupon the computer program checks that the following conditions are satisfied:
1. The path information appended to the computer program URL indicates a request for PEI rather than freely available information.
2. An access cookie 144 is included with the request, and the time indicated in that access cookie 144 has not yet expired.
3. That the requested PEI is included in the set of PEI covered by the access cookie 144.
4. That the IP address in the access cookie 144 matches the IP address of the customer sending the supplementary request 146.
5. The access cookie 144 has not been tampered with, i.e. the encoded value (hash=DDDDD) in the access cookie 144 confirms that it originated in the merchant web server 110.

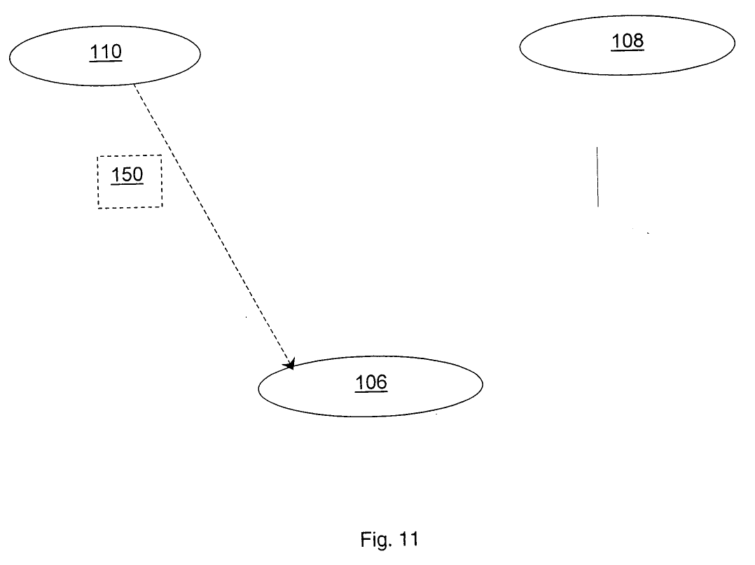

FIG. 11 shows that if these conditions are all met, the computer program will allow the merchant web server 110 to return the requested picture 150 (or other information) in response to the supplementary request 146.

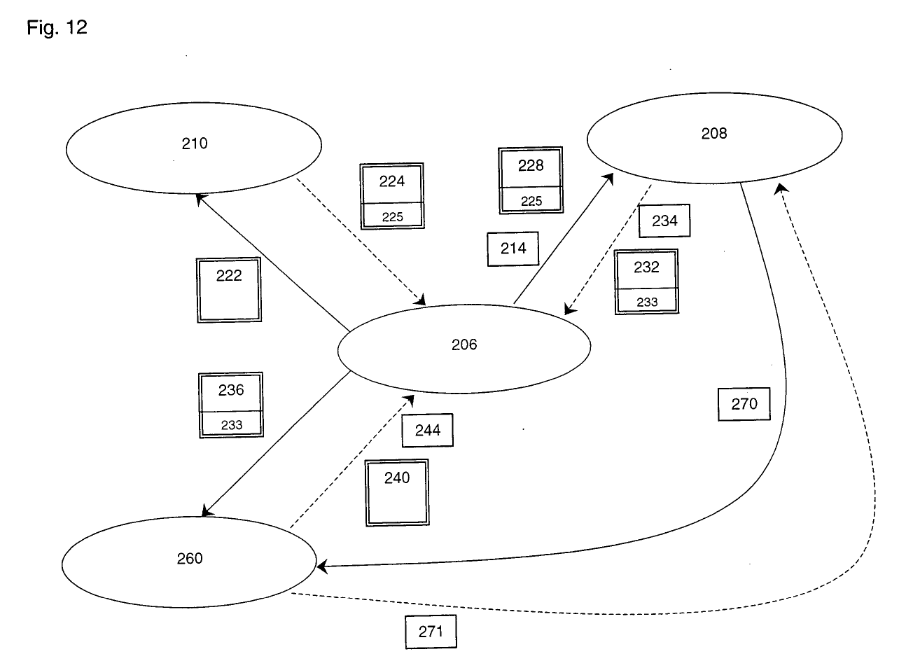

FIG. 12 shows an alternative configuration of an authorisation system according to the present invention. In this configuration, the system does not use the seed cookie to ensure security; instead, the service provider provides a time limit in which the further modified transaction request must be sent to the target merchant site for access to be granted to the requested information. This method will now be described in detail with reference to FIG. 12.

Firstly, the user (customer) clicks a link on the order web page of a merchant website. The customer web browser 206 sends a transaction request 222 to the merchant web server 210 as a result of the user clicking the link. This step corresponds to the step shown in FIG. 4 and described in detail above. Transaction request 222 contains the same information as the above-mentioned transaction request 122.

As before, the merchant web server 210 responds to the transaction request 222 by issuing a first redirection instruction 224 in the form of a HTTP redirect header telling the customer web browser 206 to redirect its request to the service provider website 208. The first redirection instruction 224 includes a first redirection URL 225, which includes:
1. An indication of the content being purchased (e.g. the location (URL) of the desired PEI);
2. The price to be charged;
3. Details of a website that refers the customer to the merchant web server 210; and
4. An encoded value which demonstrates to the service provider that the centre of the redirection instruction 224 has knowledge of the shared secret (e.g. the MD5 hash value of the URL 225 discussed above).

In this case, the URL 225 does not include a seed value identifying the transaction, neither is the first redirection instruction 224 necessarily accompanied by a seed cookie.

In response to the first redirection instruction 224, the customer web browser 206 follows the redirection by issuing a modified transaction request 228 to the service provider website 208. The modified transaction request 228 contains the first redirection URL 225, i.e. the information included by the merchant in the first redirection URL 225 is automatically sent to the service provider website 208. As discussed above, the modified transaction request 228 will be accompanied by any cookies previously issued to the customer web browser 206 by the service provider website 208. Thus, authentication cookie 214 will be returned to the service provider website 208 to indicate that the customer is still logged on.

As before, after the service provider website 208 has checked that the customer is authentically logged on, it will check its database to ascertain that the three preliminary conditions mentioned above are satisfied.

If all the preliminary conditions are satisfied, the service provider checks the first redirection URL 225 to identify the merchant and, if it is satisfied that no tampering has taken place, debit the customer account and credit the merchant account. The service provider website 208 issues a second redirection instruction 232 in the form of another HTTP redirect header to the customer web browser 206 telling it to redirect its request to a delivery website, where the information requested by the customer is stored. The delivery website 260 may be the same as the merchant website 210, but this is not necessary. For example, the first redirection URL 225 may have identified the location of the desired PEI as being in a different web domain from the merchant website 210. Thus, the second redirection instruction 232 includes a second redirection URL 233, which includes;
1. An indication of the content to be provided to the customer, e.g. encoded as additional path information appended to the URL defining the location of the desired information;
2. An encoded value which demonstrates to the merchant that the centre of the second redirection instruction 232 has knowledge of the shared secret (e.g. the hash value mentioned above);
3. A time-limit value, which sets an expiry time for the transaction. To avoid tampering, the time-limit value may be encrypted. Alternatively or additionally, the data that is used to create the hash value includes the time-limit value, so that any tampering with the time-limit value can be detected because the hash value is incorrect.

The service provider website 208 may also issue an updated balance cookie 234 at the same time as sending the second redirection instruction 232 so that the customer is aware of their new account balance.

Upon receipt of the second redirection instruction 232, the customer web browser 206 follows the HTTP redirection by issuing a further modified transaction request 236 to the merchant delivery web server 260. The address of the delivery web server 260 is included in the second redirection URL 233, and would have been notified in the original redirect instruction from the merchant order web server 210. Whereas in the first embodiment of the invention, the deliver web server needed to be in the same web domain as the order web server so that the seed cookie would automatically be returned according to HTTP protocol, in the second embodiment the delivery web server 260 need not be in the same web domain as the order web server 210. Thus, the second embodiment allows for a link on a first website (e.g. www.site1.com) to sell contents stored on a second website (e.g. www.site2.com).

In the second embodiment, the time-limit value offers protection against the response generated by the payment server from being replayed on the same or a different computer.

The merchant delivery web server 260 receives the further modified transaction request 236 from the customer web browser 206, and a computer programme stored thereon checks that the following conditions are satisfied:
1. The hash value in the second redirection URL 233 that is carried in the further modified transaction request 236 correctly demonstrates knowledge of the shared secret and that the entire coding of URL 233 has not been tampered with;
2. The time-limit value contained in the second redirection URL 233 is checked against the clock of the delivery web server 260 to check that the instruction has not expired.

If the above conditions are met, the computer programme in the delivery web server delivers the content (e.g. PEI 240) that the customer has purchased in the transaction in the same way as described above. Likewise, an access cookie 244 may be delivered at the same time at the PEI 240 to allow the customer to access the information in a supplementary request if necessary.

In order for the second embodiment to operate successfully, it is necessary for the service provider 208 to be aware of the clock value of the merchant delivery web server 260 when it sets the time-limit value. Ideally, the clock on the service provider 208 will be synchronised with the clock on the merchant delivery web server 260, but in practice this is not always possible. Instead, the service provider 208 periodically sends a request 270 to the merchant delivery website 260 to determine any difference in the clock values between those servers (sent in a response 271 from the merchant deliver web server 260). The difference in clock values is taken into account when the service provider 208 generates the time-limit value in the second redirection instruction 232. For example, the authorisation server (service provider 208) may periodically send a message to the web server 260 requesting the current time. The web server 260 replies immediately to this message indicating the current time according to the web server's internal clock. If there is a difference between the web server clock and the authorisation server (service provider) clock, the authorisation server records the difference. In any subsequent transactions, the expiry time that is sent e.g. as label xxx in the second redirection instruction 232 to the web server 260 is modified by the time difference most recently recorded for that web server 260. The service provider 208 may maintain a table of clock values for the web servers belonging to merchant for whom it holds accounts. It is not necessary to obtain new a time difference for every transaction. Typically the time difference will be considered valid for a period of some hours, after which a new time difference should be requested. This may be requested as a result of a new transaction, or independently following expiry of a set period.

The technique of the second embodiment to the invention simplifies the transaction described in the first embodiment by doing away with the seed cookie. Whilst the level of security afforded by the second embodiment is not as high as that given by the seed cookie embodiment, it gives the authorisation system a greater flexibility e.g. in its ability to allow a customer to purchase material accessible via a first web domain from a website in a second web domain. The second embodiment of the invention prevents unauthorised copying by relying on a time-limit value that tells the delivery web server that the transaction is valid for a certain period (typically short, e.g. only a few seconds). Provided the time-limit has not expired, the delivery web server will deliver the content. If the time-limit has expired, the delivery web server will recognise the access attempt as an attempt to replay the response on the same or a different computer (e.g. PC) and will reject it.

An additional advantage of the second embodiment is that the security provisions do not rely on the internet protocol address of the customer remaining constant throughout the transaction. It is possible for the address to vary during a transaction e.g. due to the use of proxy servers.

The present invention allows a customer to gain access to the requested PEI after making the required payment. This can be achieved without having to re-authenticate for each payment, and without having to authorise each payment.

1-49. (canceled)

50. A method of authorising an on-line transaction between a customer web browser and a merchant web server after the customer web browser has sent a transaction request to the merchant web server, the method including the steps of:
identifying the transaction request with a first label;
sending a data package containing the first label to the customer web browser from the merchant web server;
redirecting the customer web browser to a service provider that is remote from the merchant web server and is arranged to authenticate the identity of the customer, the redirecting step including:
providing a second label for a first redirection instruction sent from the merchant web server to the customer web browser, the second label having a first encrypted element unique to the merchant, and the first redirection instruction being separate from the data package;
including the first label in the first redirection instruction; and
sending a modified transaction request from the customer web browser to the service provider, the modified transaction request including the first and second labels included in the first redirection instruction, the second label including the first encrypted element unique to the merchant;
confirming that the customer can be party to the transaction, the confirming step including:
authenticating the first encrypted element;
providing a third label for a second redirection instruction sent from the service provider to the customer web browser, the third label having a second encrypted element unique to the service provider;
including the first label included in the modified transaction request in the second redirection instruction;
sending a further modified transaction request from the customer web browser to the merchant web server, the further modified transaction request including the first and third labels included in the second redirection instruction, the third label including the second encrypted element; and
returning the data package from the customer web browser to the merchant web server; and
authorising the transaction, the authorising step including:
authenticating the second encrypted element; and
matching the first label included in the further modified transaction request received by the merchant web server with the first label sent in the data package that is returned to the merchant web server.

51. A method according to claim 50, wherein the data package is a request cookie which is automatically returned to the merchant web server by the customer web browser when the customer web browser receives the second redirection instruction.

52. A method according to claim 51, wherein the request cookie includes the time that it was issued, the IP address of the customer web browser and a third encrypted element unique to the merchant web server, the third encrypted element being assessable to detect tampering with the request cookie.

53. A method according to claim 52, including:
checking that the data contained in the returned cookie fulfils one or more of the following conditions:
the third encrypted element corresponds to the correct merchant web server;
the cookie has existed for no longer than a predetermined time period;
the IP address in the cookie matches the IP address of the customer web browser sending the confirmation request.

54. A method according to claim 50, wherein the first redirection instruction includes a HTTP redirect header which instructs the customer web browser to send the modified transaction request to a first URL corresponding to a web site belonging to the service provider.

55. A method according to claim 50, wherein the service provider and the merchant web server share a secret such that coding of the first and second encrypted elements demonstrates knowledge of the shared secret.

56. A method according to claim 54, wherein the second redirection instruction includes a second HTTP redirect header which instructs the customer web browser to redirect the further modified transaction request to a second URL corresponding to the merchant web server.

57. A web server for authorising an on-line transaction request received from a customer web browser, the web server including:
request identifying means for giving a first label to a transaction request from the customer web browser, the request identifying means being arranged to cause a data package containing the first label to be sent to the customer web browser;
first redirection identifying means for providing the first label and a second label in a first redirection instruction sent to the customer web browser, the second label including a first encrypted element unique to the web server, the first redirection instruction being separate from the data package and causing the customer web browser to send a modified transaction request to a service provider that is remote from the merchant web server in order for the service provider to authenticate the identity of the customer, whereby a second redirection instruction is issued to the customer web browser to cause the customer web browser to send a further modified transaction request to the web server and to return the data package to the web server, the second redirection instruction and the further modified transaction request including the first label and a third label which includes a second encrypted element unique to the service provider;
authenticating means for authenticating the second encrypted element contained with the further modified transaction request received from the customer web browser; and
a computer program arranged to authorise the transaction when:
the authenticating means authenticates the second encrypted element; and
the first label included in the received further modified transaction request matches the first label in the returned data package.

58. An authorisation system for an on-line transaction between a customer web browser and a merchant web server, the system including:
a service provider that is remote from the merchant web server, the service provider being arranged to authenticate the identity of the customer;
a request identifier for giving a first label to a transaction request from the customer web browser to the merchant web server;
a first redirection identifier for providing the first label and a second label in a first redirection instruction sent from the merchant web server to the customer web browser, the second label including a first encrypted element unique to the merchant, the first redirection instruction causing the customer web browser to send a modified transaction request to the service provider, the modified transaction request including the first and second labels included in the first redirection instruction, the second label including the first encrypted element;
second redirection identifier for providing the first label included in the modified transaction request received by the service provider and a third label in a second redirection instruction sent from the service provider to the customer web browser, the third label including a second encrypted element unique to the service provider, the second redirection instruction causing the customer web browser to send a further modified transaction request to the merchant web server, the further modified transaction request including the first and third labels included in the second redirection instruction, the third label including a second encrypted element;
a expiry setter for including a fourth label indicative of a time limit in the second redirection instruction, the fourth label being included with the first and third labels in the further modified transaction request;
a first authentication portion for authenticating the first encrypted element in the modified transaction request to indicate to the service provider that the source of the first redirection instruction is trusted; and
a second authentication portion for authenticating the second encrypted element in the further modified transaction request to indicate to the merchant web server that the source of the second redirection instruction is trusted;
wherein:
the service provider is arranged so that the second redirection instruction is sent when the first authentication portion authenticates the first encrypted element; and
the system includes a computer program arranged to authorise the transaction when:
the second authentication portion authenticates the second encrypted element; and
the time limit indicated by the fourth label has not expired.

59. An authorisation system according to claim 58, wherein the second authorisation portion includes a clock, and the fourth label includes a value for comparison with the clock.

60. An authorisation system according to claim 58, wherein the merchant web server includes a merchant order web server for receiving the transaction request from the customer web browser, and a merchant delivery web server for receiving the further modified transaction request; and wherein the first redirection identifier is provided in the merchant order web server and the second authentication portion is provided in the merchant delivery web server.

61. An authorisation system according to claim 60, wherein the merchant order web server and the merchant delivery web server have different web domain names.

62. A web server for authorising an on-line transaction request received from a customer web browser, the web server including:
a request identifier for giving a first label to a transaction request from the customer web browser;
a first redirection identifier for providing the first label and a second label in a first redirection instruction sent to the customer web browser, the second label including a first encrypted element unique to the web server, the first redirection instruction causing the customer web browser to send a modified transaction request to a service provider that is remote from the merchant web server in order for the service provider to authenticate the identity of the customer, whereby a second redirection instruction is issued to the customer web browser to cause the customer web browser to send a further modified transaction request to the web server, the second redirection instruction and the further modified transaction request including a third label which includes a second encrypted element unique to the service provider and a fourth label indicative of an expiry time;
an authentication portion for authenticating the second encrypted element contained with the further modified transaction request received from the customer web browser; and
a computer program arranged to authorise the transaction when:
the authentication portion authenticates the second encrypted element; and
the time indicated by the fourth label has not expired.
